(19) United States
(12) Patent Application Publication
(10) Pub. No.: US 2004/0009051 A1
(43) Pub. Date: Jan. 15, 2004

(54) Crown fastener and method for using

(76) Inventors: Bruce R. Roberts, Midland, GA (US); Wesley J. Wagner, Columbus, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/194,545

(22) Filed: Jul. 12, 2002

(51) Int. Cl. F16B 39/282

(52) U.S. Cl. 411/187

(57) ABSTRACT

An anti-loosening fastener comprises a head having an upper side and an underside. A shank extends from the middle of the underside of the head. A nut, a concentric counter-bored section and a gripping surface are formed in the upper side of the head. A plurality of protrusions are disposed radially along a perimeter of the underside of the head. A method of use is also provided.

### TECHNICAL FIELD

The present invention is generally related to fastening devices and, more particularly, is related to an apparatus and method for quickly fastening screw-type fasteners for mechanically securing pieces together.

### BACKGROUND OF THE INVENTION

Fastening pieces together utilizing screw and nut-type fasteners is used in a myriad of applications in virtually every industry. In such applications, the nut is rotatably applied around the shaft of the screw or bolt and tightened toward the head, thereby fastening two or more members together. The present invention has utility in most, if not all, such applications and, as a representative example, a use of the invention in the grill industry will be focused upon.

In the grill industry, many of the grill assemblies are shipped to consumers or retailers in a box and substantially unassembled. Accordingly, upon purchasing or receipt of the grills, the consumer or retailer must typically assemble the grill.

In particular, the assembly of a grill often requires the attachment of side shelves to the support structures of the grill. In the past, the attachment of side shelves to the support structure has involved the affixing of multiple screws, bolts or other types of fastening devices. In many instances, the person assembling the grill may be required to use several different tools, such as screwdrivers, nut drivers, wrenches, etc. to firmly engage the fastening devices through the support structures and into the shelves.

For the individual consumer, who may not own a large range of tools, the assembly of a grill may be hampered or slowed because of the difficulties associated with attaching the shelves to the support structure. Additionally, the use of hand tools may be cumbersome and time consuming. For the retailer that pre-assembles grills for its customers, the ability to assemble the grills as quickly as possible is important to increasing the efficiency of the employees and the profitability of providing pre-assembled grills. In this regard, many people assembling grills prefer to use power tools as opposed to hand tools. Often when using power tools, the assembler will over-tighten or under-tighten the fasteners. If the fasteners are affixed too tightly, damage to the fasteners, the support structure or the shelves may occur. Conversely, if the fasteners are affixed too loosely, the shelves will not be securely attached to the grill support structure and could result in damage to the shelf or support structure. Moreover, improperly attached shelves may pose a risk of injury.

Additionally, the types of fastening devices that are typically utilized may become loose or disengage from their positions as the grill is used over time or moved from location to location. To avoid this problem, often the person assembling the grill will over-tighten the fastening devices, resulting in damage to the fastener, the shelf or the support structures. Furthermore, the fastening devices currently known in the art require the person assembling the grill to use tools in order to tighten the fasteners and to secure the shelves to the support structure. Moreover, unless the owner of the grill periodically checks the security of the fasteners, it is difficult for one to be sure that the shelf is securely attached to the support structure.

Thus, a heretofore unaddressed need exists in the industry to provide a fastening device for the safe and secure attachment of shelves to grill support structures that addresses the aforementioned deficiencies and inadequacies. In particular, a fastening device is desired that is easy to tighten by hand, with hand tools or with power tools; that prevents loosening of the fasteners over time; and that provides an indicator to inform the person assembling the grill that the fastener is adequately secured.

### SUMMARY OF THE INVENTION

Preferred embodiments of the present invention provide a crown fastener apparatus and method of use. Briefly described, in architecture, one embodiment of the apparatus can be implemented as follows. An anti-loosening fastener comprises an head having an upper side and an underside. A shank extends from the middle of the underside of the head. A nut, a concentric counter-bored section and a gripping surface are formed in the upper side of the head. A plurality of protrusions are disposed radially along a perimeter of the underside of the head.

Preferred embodiments of the present invention can also be viewed as providing methods of using a crown fastener. In this regard, one embodiment of such a method, among others, can be broadly summarized by the following steps: aligning pre-drilled holes disposed in the support structure with corresponding pre-drilled holes in the shelf; inserting a screw into the pre-drilled holes; and engaging a fastening device with the screw, wherein the fastening device comprises a shank and a head comprising a nut, concentric counter-bored section, and gripping surface along an upper side of the head and further comprising a plurality of protrusions along an underside of the head. The method further comprises the steps of: screwing the fastening device in a direction that tightens the shelf to the support structure; and tightening the fastening device until a ratcheting effect is realized.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top view of an embodiment of a crown fastener of the present invention.

FIG. 2 is a side view of an embodiment of the crown fastener illustrated in FIG. 1.

FIG. 3 is a perspective view of an embodiment of the crown fastener illustrated in FIG. 1.

FIG. 4 is an underside view of a typical side shelf showing pre-drilled holes through which a screw extends for engagement by the crown fastener illustrated in FIG. 1.

FIG. 5 is a side view of a portion of a grill assembly showing the attachment of a shelf to a grill support structure using the crown fasteners illustrated in FIG. 1.

### DETAILED DESCRIPTION OF THE PREFERRED EMBODIMENTS

The crown fastener 10 of the present invention is configured for use in securing a first member of a multi-member structure to a second member of the multi-member structure. For example, the crown fastener 10 can be configured for use in securing a shelf 24 to a support structure of a grill. During assembly of various structures, it is often desirable to have a relatively efficient manner in which to securely attach the members comprising the structure together in order to assemble the structure. In continuing the example of a grill, grills often have shelves that need to be fixed to a support structure. It should be noted that the crown fastener 10 of the present invention can be applied to any number of structures where it is desirable to fix a first member to a second member in a relatively easy and stable manner. The present invention provides an improved fastener for such purposes. Although the assembly of a grill is discussed herein, it should be noted that application of the crown fastener for assembly of a grill is a mere example and should not be considered a limitation of the present disclosure.

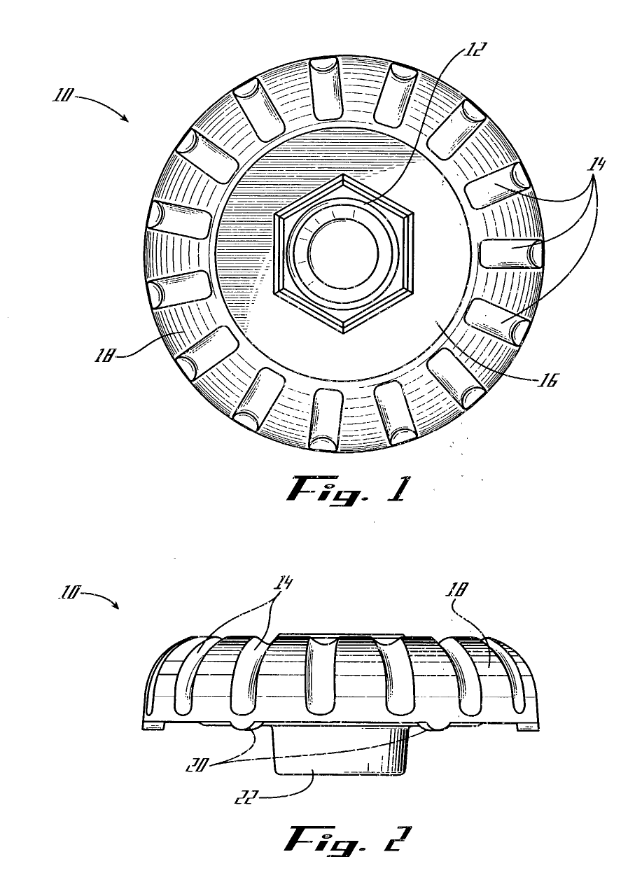

As shown in FIGS. 1-3, the crown fastener 10 is styled with a shank 22 and a unique head 18 having a nut 12 and a concentric counter-bored section 16. The counter-bored section 16 surrounds the nut 12 and has a diameter greater than that of the nut 12. The interior of the nut 12 is hollowed through the head of the fastener into the shank and is further configured with threading to receive a screw, or the like. The interior of the nut 12 is also configured such that a screwdriver, or the like, may be used to tighten the crown fastener 10. The exterior of the nut 12 is hexagonally configured such that a nut driver, wrench, or any suitable tool can also be used to tighten the crown fastener 10.

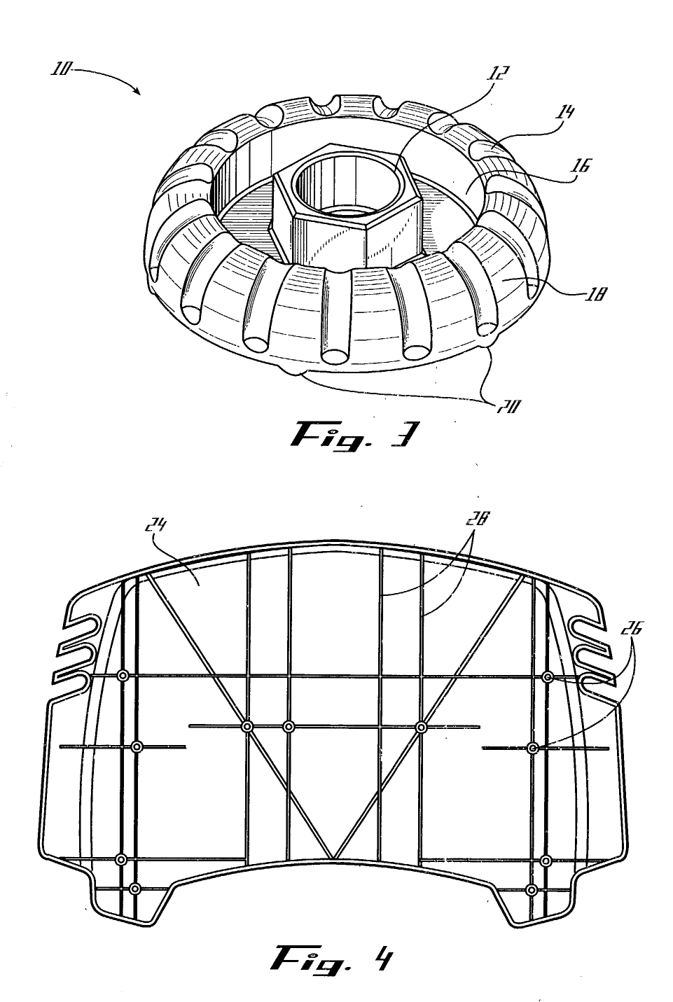

Along the outside-top and side perimeter of the head 18, surrounding the counter-bored section 16, are ridges 15 and grooves 14 forming a gripping surface 17. This gripping surface 17 is configured such that the crown fastener 10 may be hand-tightened or a larger wrench or other tool may be used on the outer perimeter of the head 18 to tighten the crown fastener 10. As shown in FIGS. 2 and 3, located radially along the underside of the perimeter of the head 18, are a series of bumps or protrusions 20. These protrusions 20 are preferably spaced substantially equally apart and with sufficient distance therebetween to engage the diameter or width of a tube 30 of a grill support structure. It should be noted that although discussed and illustrated herein as having a diameter, the tube 30 can comprise any suitable cross-section measurement, including but not limited to a diameter, width, etc.

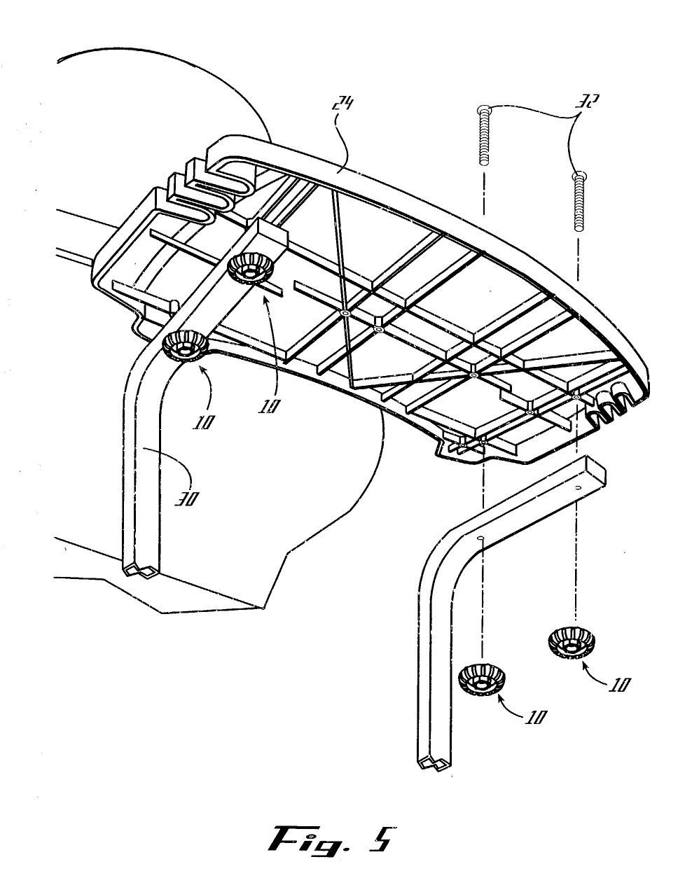

As shown in FIG. 4, the shelf 24 is configured with a plurality of pre-drilled holes 26 disposed therein. These pre-drilled holes 26 align with corresponding pre-drilled holes 26 disposed in the tubes 30 of the support structure during assembly. A screw 32 (see FIG. 5) or the like extends through the aligned, pre-drilled holes 26 of both the shelf 24 and the tubes 30, the end of which screw 32 is threadably engaged to the crown fastener 10.

As illustrated in FIG. 5, the crown fastener 10 engages the screws 32, which extend through the pre-drilled holes 26 in the tubes 30 of the grill support structure and into pre-drilled holes 26 in the underside of a grill shelf 24. As the crown fastener 10 is tightened into position using one's hand, hand tools or power tools, the top of the tubes 30 of the grill support structure and the underside of the shelf 24 are drawn together securely. The shelf 24 is reinforced with support struts 28 which abut the tubes 30 of the support structure and through which the pre-drilled holes 26 are configured.

During assembly, one can determine that the crown fasteners 10 have been sufficiently tightened when a ratcheting effect is realized. The ratcheting effect is exhibited when the protrusions 20 on the underside of the head 18 of the crown fasteners 10 are brought into contact with the tubes 30 of the grill support structure as the crown fasteners 10 are tightened onto the screws 32. In this manner, the protrusions 20 rotate past a gripping point on the outer diameter of the tubes 30, such as an edge on squared tubes or the outermost point on rounded tubes, and “lock” into position as the crown fasteners 10 are tightened. As used herein, the term “lock” does not mean to become permanently affixed into position. Instead, “lock” is used to indicate that the crown fastener 10 does not easily twist from its position without exertion of sufficient force to disengage the protrusions 20 from their gripping points on the outer diameter of the tubes 30 of the grill support structure.

Because the protrusions 20 are symmetrically located around the outer perimeter of the head 18, this symmetry allows for even tightening of the crown fasteners 10 and results in a ratcheting effect as the crown fasteners 10 are rotated. Accordingly, in one embodiment, the spacing of the protrusions 20 is such that every sixty degrees of rotation of the crown fastener 10 yields another locking point. The locking points and corresponding ratcheting effect aid in determining when the crown fastener 10 is sufficiently tightened and further prevent loosening of the crown fasteners 10 as the grill is used and moved. In this manner, the shelves 24 are firmly secured to the tubes 30 of the grill support structure.

The present invention may also be viewed as a method for securing a shelf 24 to a grill support structure. One embodiment of such a method, can be broadly summarized by the following steps: aligning the pre-drilled holes 26 in the tubes 30 of the grill support structure with corresponding pre-drilled holes 26 in the shelf 24; insertion of the screws 32 into the aligned, pre-drilled holes 26 of the tubes 30 and the shelf 24; threading the crown fastener 10 onto the screw 32 to a sufficient degree such that it engages the tubes 30 of the grill support structure; tightening the crown fastener 10 so as to secure the shelf 24 against the tubes 30; and observing a ratcheting effect caused by the locking of the protrusions 20 into position about the tubes 30 of the grill support structure so as to ensure that the crown fastener 10 has sufficiently tightened and secured the shelf 24 against the tubes 30 of the tubular support structure.

It is envisioned that the crown fastener 10 may be constructed of any material suitable for application as a fastening device in a grill assembly. Particularly, the crown fastener 10 may be formed of plastic, metal or a combination of materials. In a preferred embodiment, the crown fastener 10 is constructed of a plastic material.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. An anti-loosening fastener, comprising:
a head having an upper side and an underside;
a shank extending from the middle of said underside of said head;
a nut, a concentric counter-bored section and a gripping surface formed in the upper side of said head; and
a plurality of protrusions disposed radially along a perimeter of said underside of said head.

2. The fastener of claim 1, wherein said nut is centrally configured in said head and is surrounded by said counter-bored section, where said counter-bored section has a diameter greater than that of said nut, and said counter-bored section is surrounded by said gripping surface, where said gripping surface is formed outside of said counter-bored section and comprises a diameter greater than that of said counter-bored section.

3. The fastener of claim 1, wherein said nut further comprises:
a hollow, threaded interior section extending therethrough, said interior section being configured to accept a tool that engages within the interior section of the nut for receiving or releasing of the fastener; and
an exterior section, said exterior section being hexagonally configured to accept a tool that engages about the exterior section of the nut for tightening or loosening the fastener.

4. The fastener of claim 1, wherein the gripping surface comprises a plurality of ridges and grooves along a perimeter of the upper side of the head.

5. The fastener of claim 1, wherein the plurality of protrusions disposed radially along the perimeter of the underside of said head are symmetrically spaced and configured to accept a diameter of a tube of a support structure and exhibit a ratcheting effect as the fastener is turned against the tube.

6. The fastener of claim 5, further comprising protrusions spaced such that every 60 degrees of rotation of the fastener ratchets the fastener into a locking point about the tube.

7. The fastener of claim 1, wherein said shank is threaded for engagement with a threaded screw extending through pre-drilled holes for fastening of a shelf to a support structure.

8. A method for securing a shelf to a tubular support structure, comprising the steps of:
aligning pre-drilled holes disposed in the tubular support structure with corresponding pre-drilled holes in the shelf;
inserting a screw into said pre-drilled holes;
engaging a fastening device with the screw, wherein the fastening device comprises a shank and a head comprising a nut, concentric counter-bored section, and gripping surface along an upper side of said head and further comprising a plurality of protrusions along an underside of said head;
screwing said fastening device in a direction that tightens the shelf to the tubular support structure; and
tightening said fastening device until a ratcheting effect is realized.

9. The method of claim 8, wherein the shank of said fastening device is configured with threading for screwing said fastening device into position and tightening the shelf to the tubular support structure.

10. The method of claim 8, wherein said fastening device is further defined by a central configuration of the nut in the head and said nut is surrounded by the counter-bored section, where said counter-bored section has a diameter greater than that of said nut, and the counter-bored section is surrounded by the gripping surface, where said gripping surface is formed outside of the counter-bored section and has a diameter greater than that of said counter-bored section.

11. The method of claim 8, wherein said fastening device may be screwed into position by engagement of the screw through the shank and with the interior section of the nut.

12. The method of claim 8, wherein said fastening device may be screwed into position by engagement of an interior section or exterior section of the nut with a tool, where the interior section is configured to accept a tool that engages within the interior section of the nut for tightening or loosening of the fastener, and where the exterior section is hexagonally configured to accept a tool that engages about the exterior of the nut for alternately tightening and loosening said fastener.

13. The method of claim 8, wherein said fastening device may be screwed into position by engagement of the gripping surface, where said gripping surface is configured with a plurality of ridges and grooves along an upper side perimeter of the head.

14. The method of claim 8, wherein the ratcheting effect is produced by the engagement of the plurality of protrusions against a gripping point on the tubular support structure.

15. The method of claim 14, wherein the plurality of protrusions are radially and symmetrically spaced along a perimeter of the underside of said head and said plurality of protrusions are configured to accept a diameter of a tube of the tubular support structure, such that the ratcheting effect is realized as the fastener is turned against the gripping point on the tubular support structure.

16. A multi-member structure being assembled when members comprising said multi-member structure are fixed together, said multi-member structure comprising:
a first member having at least one pre-drilled hole disposed therein;
a second member having at least one pre-drilled hole disposed therein; and
an anti-loosening fastener, comprising:
a head having an upper side and an underside;
a shank extending from the middle of said underside of said head;
a nut, a concentric counter-bored section and a gripping surface formed in the upper side of said head; and
a plurality of protrusions disposed radially along a perimeter of said underside of said head;
wherein said pre-drilled hole of said first member is aligned with said pre-drilled hole of said second member and said first member is fixed to said second member by said anti-loosening fastener engaging said aligned pre-drilled holes.

17. The multi-member structure of claim 16, wherein said multi-member structure comprises a barbecue grill assembly.

18. The multi-member structure of claim 16, wherein said plurality of protrusions disposed radially along the perimeter of the underside of said head are symmetrically spaced and configured to accept a diameter of one of said first member and said second member and exhibit a ratcheting effect as the fastener is turned against the member.

19. The multi-member structure of claim 16 wherein said plurality of protrusions are spaced such that at pre-determined degrees of rotation of the fastener ratchets said fastener into a locking point about one of said first member and said second member.
